(19) United States
(12) Patent Application Publication
(10) Pub. No.: US 2006/0271442 A1
(43) Pub. Date: Nov. 30, 2006

(54) Method for placing an order utilizing a personal digital device

(76) Inventors: Gerald W. Pfleging, Batavia, IL (US); Rachel M. Pfleging, Batavia, IL (US); George Paul Wilkin, Bolingbrook, IL (US)

Correspondence Address: Lucent Technologies Inc.;Docket Administrator - Room 3J-219, 101 Crawfords Corner Road, Holmdel, NJ, 07733-3030, US

(21) Appl. No.: 11/138,150

(22) Filed: May 26, 2005

(51) Int. Cl. G06Q 30/00

(52) U.S. Cl. 705/26

(57) ABSTRACT

The present invention provides a method for placing an order utilizing a personal digital device. Communication is established between a personal digital device and an ordering unit, such as the drive through ordering unit located at a restaurant. The communication is established using a wireless protocol. The personal digital device places an order with the ordering unit using the wireless protocol. The personal digital device can also pay for the order by sending payment information to the ordering unit using the wireless protocol.

### FIELD OF THE INVENTION

The present invention relates generally to personal digital devices, and more particularly to a method for using a personal digital device for transmitting orders.

### BACKGROUND OF THE INVENTION

In order to attract new customers and increase business, restaurants have included an increasing number of menu choices. In addition, in order to please customers, restaurants have allowed customers to customize their choices. The addition of additional menu items with the option of order customization has increased the burden on restaurant employees. Accuracy and timeliness of orders is a continuing problem for restaurants, especially fast-food restaurants.

Many fast-food restaurants have drive through service that allows a customer to obtain food without exiting their vehicle. Typical ordering and order verification occur via a speaker and microphone element. The voice quality on such speakers and microphones is often poor, which leads to a repetition of orders, and often an incorrect order. The customer is then required to check the order prior to driving off, and if the order is wrong, parking their vehicle and entering the restaurant to correct the order. Further, any customization of the order is difficult due to the poor quality of the microphone used, as well as the ambient noise of the restaurant which often leads to erroneous orders.

Therefore, a need exists for a method for processing a customer's order at a restaurant that allows the customer to quickly and efficiently order and receive their food.

### BRIEF SUMMARY OF THE INVENTION

The present invention provides a method for placing self-service orders at restaurants or the like using wireless transmissions from a PDA or similar device. The present invention provides an improved accuracy in food orders as well as a decreased wait time for food.

In accordance with an exemplary embodiment of the present invention, communication is established between a personal digital device and an ordering unit. The communication can be established in a drive-through lane of a fast food restaurant, with a self-service kiosk located within a restaurant or store, or with a portable device utilized by a waiter, waitress, or server within a restaurant.

The wireless protocol established between the personal digital device and the ordering unit can be chosen by the user, the restaurant employee, or automatically. In the automatic scenario, the personal digital device and the ordering unit employ handshaking or other techniques, such as pinging or ACK/NACK protocols, to determine which wireless protocol should be used to transfer information therebetween. As examples of wireless protocols that can be used, the wireless protocol can be IrDA (Infrared Data Association), Bluetooth, 2.5/3.X/4.X generation wireless systems, Wi-Fi, Wi-Max, or cellular technology.

The personal digital device can send various forms of identification to the ordering unit, such as information used to identify the user, such as the name, account number, license plate number, the table number, or any other information that can uniquely identify the user.

The user utilizes the personal digital device to place an order via the ordering unit. The user of the personal digital device can choose the type and quantities of items and also make any customized order changes. The user then transmits the order to the ordering unit using the personal digital device. The order is transmitted using the over-the-air protocol determined earlier. The order can include information associated with the user, such as the license plate number of the car that the user placed the order from. In this manner, the order can be effectively and accurately delivered to the right user.

The ordering unit confirms the order placed by the personal digital device. The ordering unit preferably utilizes the same over-the-air protocol used by the personal digital device during ordering. The order confirmation preferably includes a list of the items purchased, the number of each item purchased, any special orders or changes to the normal ingredients used in the items, the total cost of the order, and the date and time. The confirmation can also include ads or other special offers transmitted to the personal digital device. The special offers can include, for example, ads for new products, current food processing times, lists of current and upcoming specials and events, nutrition information, or ingredient lists.

The ordering unit determines if the user of the personal digital device wants to pay for the order via the personal digital device. The ordering unit preferably sends a query message to the personal digital device to determine if the personal digital device wants to pay for the order via the personal digital device. If the user wants to use the personal digital device to pay for the order, the personal digital device transmits payment information to the ordering unit. The personal digital device sends, preferably encrypted, credit or debit card information to the ordering unit.

### BRIEF DESCRIPTION OF THE SEVERAL VIEWS OF THE DRAWINGS

FIG. 1 depicts a wireless food ordering system in accordance with an exemplary embodiment of the present invention.

FIG. 2 depicts a flowchart of a method for placing an order utilizing a personal digital device in accordance with an exemplary embodiment of the present invention.

### DETAILED DESCRIPTION OF THE INVENTION

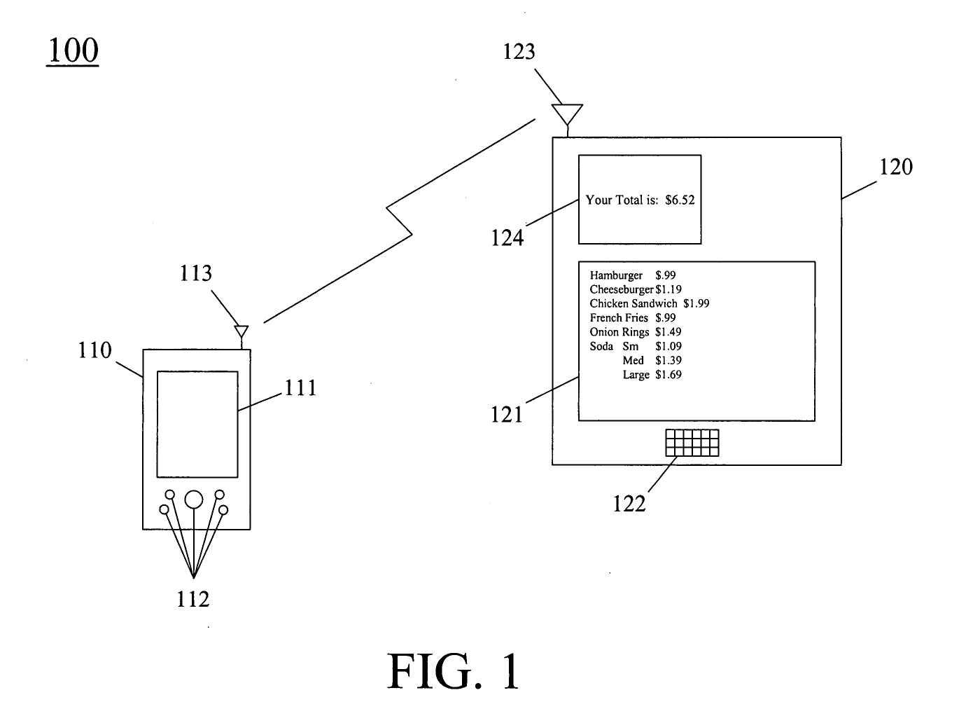

FIG. 1 depicts a wireless food ordering system 100 including a personal digital device 110 and an ordering unit 120 in accordance with an exemplary embodiment of the present invention. Ordering unit 120 is typically located in a restaurant or other area where food, goods or services are sold.

Personal digital device 110 is a personal device that is capable of transmitting and receiving signals to and from ordering unit 120 without being physically connected to ordering unit 120. Personal digital device 110 can be a PDA (Personal Digital Assistant), a computer, a cell phone, a watch, or any other device capable of receiving a wireless signal from another device. As depicted in FIG. 1, personal digital device 110 is a PDA.

Personal digital device 110 includes display 111, input buttons 112, and transceiver 113. Display 111 can be an LCD (Liquid Crystal Display) screen, a TFT (thin-film transistor) technology, CSTN (color super-twist nematic) technology, or any other display capable of presenting an image to a user.

Input buttons 112 are depicted on personal digital device 110. Input buttons 112 allow a user to make selections and enter information into personal digital device 110. Although personal digital device 110 is depicted with input buttons 112, personal digital device 110 may include a variety of means for inputting data or selections into personal digital device 110. For example, personal digital device 110 may include a stylus, a touch screen, a mouse, a keyboard, or any other device capable of inputting data into personal digital device 110.

Transceiver 113 is preferably an antenna that allows personal digital device 110 to communicate with other wireless devices. Transceiver 113 may communicate using IrDA (Infrared Data Association) technology, Bluetooth, 2.5/3.X/4.X generation wireless systems, Wi-Fi, Wi-Max, cellular technology, or any other wireless protocol.

Ordering unit 120 is preferably a wall-mounted or free-standing board that lists the food choices and associated prices for the items available at the restaurant. Although the exemplary embodiment of the present invention depicted in FIG. 1 relates to a restaurant, the present invention can be utilized in any place of business that provides goods or services for purchase or rental. For example, ordering unit 120 could be associated with a hair salon, and could list the types of services provided, such as haircut, perm, style, hair washing, etc., as well as the price for each of these services. Ordering unit 120 can also be associated with goods sold at a store, in which case ordering unit 120 would send the price and quantity of items available on-site for purchase, as well as provide detailed descriptions of the products. A user could place orders with ordering unit 120 via personal digital device 110, and pick up the orders at a delivery bay or the like.

Ordering unit 120 can also be a portable unit that is utilized by a restaurant server. In this embodiment, the user of personal digital device 110 can send and receive information with the ordering unit.

Ordering unit 120 includes product information display 121, speaker/microphone 122, transceiver 123, and display 124. Information display 121 includes a list of the items for sale and their associated price. The list could include specials, combinations, and other information about the items offered for sale.

Speaker/microphone 122 provides an interface for users that are not using a personal digital device. Speaker/microphone 122 is commonly used in drive-through applications to provide the ability for the drive-through customer to place an order and receive verbal confirmation from restaurant employees. The present invention makes the use of speaker/microphone 122 unnecessary.

Transceiver 123 is preferably an antenna that allows communication to and from another wireless device. In an exemplary embodiment, transceiver 123 transmits and receives signals utilizing the same wireless protocol as transceiver 113 on personal digital device 110.

Display 124 provides a visual representation of the purchases for viewing by a consumer. Display 124 can be any suitable technology, such as an LED (Light Emitting Diode), LCD, or the like. Display 124 is effectively replaced by display 111 on personal digital device 110 utilizing the present invention. By transmitting the status of the order over-the-air to personal digital device 110 to be displayed on display 111, display 124 is not needed to provide a visual indication of the user's order.

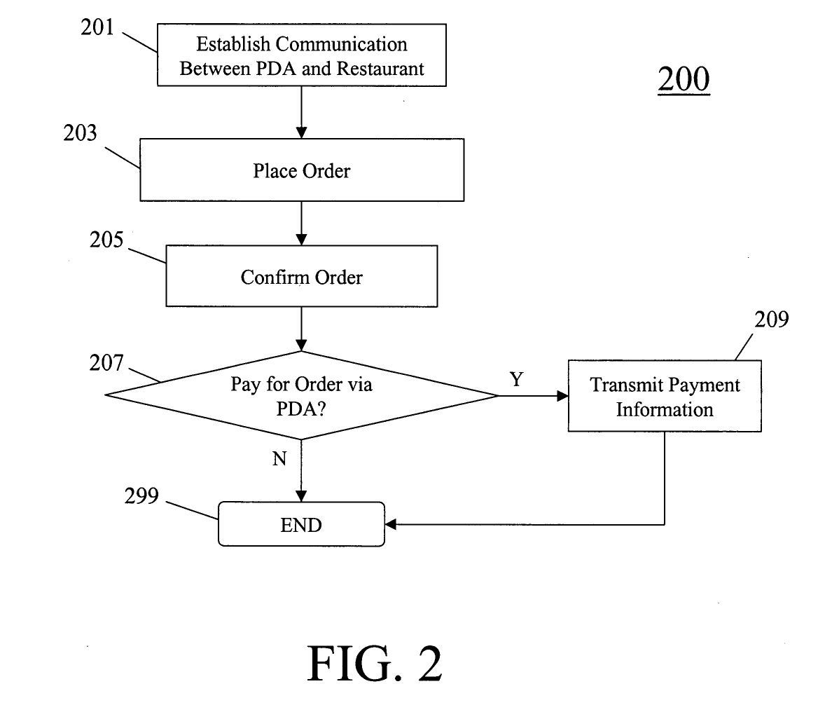

FIG. 2 depicts a flowchart 200 of a method for placing an order utilizing a personal digital device in accordance with an exemplary embodiment of the present invention.

Communication is established (201) between personal digital device 110 and ordering unit 120. In an exemplary embodiment of the present invention, a user of personal digital device 110 utilizes a drive-through lane of a fast-food restaurant or the like. To facilitate processing of orders, the restaurant could offer a separate drive through lane for customers who use a personal digital device to place their order. Alternately, the restaurant could limit the range of ordering unit 120 such that a drive through customer is able to place an order only when it is in a place in line in which it could verbally place an order.

In a further exemplary embodiment, ordering unit 120 could be a portable unit carried by a server in a restaurant. In this embodiment, a user of personal digital device 110 could place an order utilizing personal digital device 110 or could request the presence of the server in order to place their order. Further, the user could request refills, the check, or the server to clear dishes from the table.

The wireless protocol established between personal digital device 110 and ordering unit 120 can be chosen by the user, the restaurant employee, or automatically. In the automatic scenario, personal digital device 110 and ordering unit 120 employ handshaking or other techniques to determine which wireless protocol should be used to transfer information therebetween. For example, ordering unit 120 may send out a ping signal for each of the wireless protocols that it supports. Ordering unit 120 then waits to determine if it receives a response back from a personal digital device. This response would indicate to ordering unit 120 which protocol should be used to communicate with personal digital device 110. As examples of wireless protocols that can be used, the wireless protocol can be IrDA (Infrared Data Association), Bluetooth, 2.5/3.X/4.X generation wireless systems, Wi-Fi, Wi-Max, or cellular technology.

The information sent during this step can include information used to identify the user, such as the name, account number, license plate number, the table number, or any other information that can uniquely identify the user.

The user utilizes personal digital device 110 to place (203) an order via ordering unit 120. The user of personal digital device 110 can choose the type and quantities of items and also make any customized order changes. The user of personal digital device 110 transmits the order to ordering unit 120 utilizing the over-the-air protocol established at step 201. The order can include information associated with the user, such as the license plate number of the car that the user placed the order from. In this manner, the order can be effectively and accurately delivered to the right user.

Ordering unit 120 confirms (205) the order placed by personal digital device 110. In an exemplary embodiment, ordering unit 120 utilizes the same over-the-air protocol used by personal digital device 110 during ordering. The order confirmation preferably includes a list of the items purchased, the number of each item purchased, any special orders or changes to the normal ingredients used in the items, the total cost of the order, and the date and time. In an exemplary embodiment of the present invention, the confirmation can also include ads or other special offers transmitted to personal digital device 110. The special offers can include, for example, ads for new products, current food processing times, lists of current and upcoming specials and events, nutrition information, or ingredient lists.

Ordering unit 120 determines (207) if the user of personal digital device 110 wants to pay for the order via personal digital device 100. In an exemplary embodiment, ordering unit 120 sends a query message to personal digital device 110 to determine if personal digital device 110 wants to pay for the order via personal digital device 110. If the user does not want to pay for the order utilizing personal digital device 110, the process ends (299).

If the user wants to use personal digital device 110 to pay for the order as determined at step 207, personal digital device 110 transmits (209) payment information to ordering unit 120. In an exemplary embodiment, personal digital device 110 sends credit or debit card information to ordering unit 120. The payment information is preferably encrypted to add security to this financial transaction. The process then ends (299).

While this invention has been described in terms of certain examples thereof, it is not intended that it be limited to the above description, but rather only to the extent set forth in the claims that follow.

We claim:

1. A method for placing an order utilizing a personal digital device, the method comprising:
establishing communication between a personal digital device and an ordering unit, the communication using a wireless protocol; and
placing an order by the personal digital device with the ordering unit utilizing the wireless protocol.

2. A method for placing an order utilizing a personal digital device in accordance with claim 1, the method further comprising the step of confirming the order by the ordering unit by sending a confirmation message to the personal digital device utilizing the wireless protocol.

3. A method for placing an order utilizing a personal digital device in accordance with claim 2, wherein the confirmation message includes a detailed list of the order.

4. A method for placing an order utilizing a personal digital device in accordance with claim 2, wherein the confirmation message includes advertisements.

5. A method for placing an order utilizing a personal digital device in accordance with claim 2, wherein the confirmation message includes special offers.

6. A method for placing an order utilizing a personal digital device in accordance with claim 2, wherein the confirmation message includes an estimation of the order completion time.

7. A method for placing an order utilizing a personal digital device in accordance with claim 1, the method further comprising the steps of:
determining if the personal digital device wants to pay for the order using the personal digital device; and
if the personal digital device wants to pay for the order using the personal digital device, transmitting payment information to the ordering unit.

8. A method for placing an order utilizing a personal digital device in accordance with claim 1, wherein the step of establishing communication between a personal digital device and an ordering unit comprises sending a plurality of ping signals from the ordering unit, the plurality of ping signals including each of the wireless protocols that the ordering unit supports.

9. A method for placing an order utilizing a personal digital device in accordance with claim 1, the method further comprising the step of paying for the order by transmitting payment information from the personal digital device to the ordering unit using the wireless protocol.

10. A method for receiving an order at a drive-through restaurant including an ordering unit, the method comprising:
establishing communication between a personal digital device and the ordering unit in a drive-through lane of the restaurant using a wireless protocol; and
receiving an order from the personal digital device at the ordering unit utilizing the wireless protocol.

11. A method for receiving an order at a drive-through restaurant in accordance with claim 10, wherein the restaurant includes a separate drive-through lane for customers utilizing a personal digital device.

12. A method for receiving an order at a drive-through restaurant in accordance with claim 10, wherein the step of receiving an order from the personal digital device comprises receiving an order from the personal digital device only when it is in a place in line in which it could verbally place an order.

13. A method for receiving an order at a drive-through restaurant in accordance with claim 10, wherein the order includes information pertaining to the personal digital device.

14. A method for receiving an order at a drive-through restaurant in accordance with claim 13, wherein the information pertaining to the personal digital device comprises the license plate associated with a car that the personal digital device is placing the order from.

15. A method for receiving customer requests from a personal digital device at an ordering unit, the ordering unit being a portable unit, the method comprising:
assigning an ordering unit to a server in a restaurant;
establishing communication between a personal digital device and the ordering unit using a wireless protocol; and
receiving a customer request from the personal digital device at the ordering unit utilizing the wireless protocol.

16. A method for receiving customer requests from a personal digital device at an ordering unit in accordance with claim 15, wherein the step of receiving a customer request comprises receiving a food order from the personal digital device at the ordering unit utilizing the wireless protocol.

17. A method for receiving customer requests from a personal digital device at an ordering unit in accordance with claim 15, wherein the step of receiving a customer request comprises receiving a presence request for the server from the personal digital device at the ordering unit utilizing the wireless protocol.

18. A method for receiving customer requests from a personal digital device at an ordering unit in accordance with claim 15, wherein the step of receiving a customer request comprises receiving a request to refill drinks from the personal digital device at the ordering unit utilizing the wireless protocol.

19. A method for receiving customer requests from a personal digital device at an ordering unit in accordance with claim 15, wherein the step of receiving a customer request comprises receiving a request for a bill for the server from the personal digital device at the ordering unit utilizing the wireless protocol.

20. A method for receiving customer requests from a personal digital device at an ordering unit in accordance with claim 15, wherein the step of receiving a customer request comprises receiving a customer request including customer information from the personal digital device at the ordering unit utilizing the wireless protocol.
